(19) United States
(12) Patent Application Publication
(10) Pub. No.: US 2008/0005679 A1
(43) Pub. Date: Jan. 3, 2008

(54) Context specific user interface

(75) Inventors: Emily K. Rimas-Ribikauskas, Seattle, WA (US); Arnold M. Lund, Sammamish, WA (US); Corinne S. Sherry, Seattle, WA (US); Dustin V. Hubbard, Sammamish, WA (US); Kenneth D. Hardy, Redmond, WA (US); David Jones, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/478,263

(22) Filed: Jun. 28, 2006

(51) Int. Cl. G06F 3/00

(52) U.S. Cl. 715/745

(57) ABSTRACT

Various technologies and techniques are disclosed that modify the operation of a device based on the device's context. The system determines a current context for a device upon analyzing at least one context-revealing attribute. Examples of context-revealing attributes include the physical location of the device, at least one peripheral attached to the device, at least one network attribute related to the network to which the device is attached, a particular docking status, a past pattern of user behavior with the device, the state of other applications, and/or the state of the user. The software and/or hardware elements of the device are then modified based on the current context.

### BACKGROUND

In today's mobile world, the same device is carried around with a user from home, to the office, in the car, on vacation, and so on. The features that the user uses on the same device vary greatly with the context in which the user operates the device. For example, while at work, the user will use certain programs that he/she does not use at home. Likewise, while the user is at home, he/she will use certain programs that he/she does not use at work. The user may manually make adjustments to the program settings depending on these different scenarios to enhance the user experience. This manual process of adjusting the user experience based on context can be very tedious and repetitive.

### SUMMARY

Various technologies and techniques are disclosed modify the operation of a device based on the device's context. The system determines a current context for a device upon analyzing at least one context-revealing attribute. Examples of context-revealing attributes include the physical location of the device, at least one peripheral attached to the device, one or more network attributes related to the network to which the device is attached, a particular docking status, a past pattern of user behavior with the device, the state of other applications, and/or the state of the user. The software and/or hardware elements of the device are then modified based on the current context. As a few non-limiting examples of software adjustments, the size of at least one element on the user interface can be modified; a particular content can be included on the user interface; a particular one or more tasks can be promoted by the user interface; a visual, auditory, and/or theme element of the user interface can be modified; and so on. As a few non-limiting examples of hardware adjustments, one or more hardware elements can be disabled and/or changed in operation based on the current context of the device.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a context detector application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in modifying various user interface elements based on device context.

FIG. 5 is a process flow diagram for one implementation of the system of FIG. 1 illustrating the stages involved in determining a current context of a device.

FIG. 6 is a process flow diagram for one implementation of the system of FIG. 1 illustrating the stages involved in determining a visually impaired current context of a device.

FIG. 7 is a process flow diagram for one implementation of the system of FIG. 1 that illustrates the stages involved in determining a physical location of the device to help determine context.

FIG. 8 is a process flow diagram for one implementation of the system of FIG. 1 that illustrates the stages involved in determining one or more peripherals attached to the device to help determine context.

FIG. 9 is a process flow diagram for one implementation of the system of FIG. 1 that illustrates the stages involved in determining a docking status to help determine context.

FIG. 10 is a process flow diagram for one implementation of the system of FIG. 1 that illustrates the stages involved in analyzing past patterns of user behavior to help determine context.

FIG. 11 is a simulated screen for one implementation of the system of FIG. 1 that illustrates adjusting user interface elements of a device based on a work context.

FIG. 12 is a simulated screen for one implementation of the system of FIG. 1 that illustrates adjusting user interface elements of a device based on a home context.

FIG. 13 is a simulated screen for one implementation of the system of FIG. 1 that illustrates transforming the device into a photo slideshow player based on a picture frame cradle the device is docked in.

FIG. 14 is a simulated screen for one implementation of the system of FIG. 1 that illustrates transforming the device into a music player based on a car context.

FIG. 15 is a simulated screen for one implementation of the system of FIG. 1 that illustrates transforming the device into a navigation system based on a car context.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that determines the context of a device and/or adjusts the user experience based on the device's context, but the system also serves other purposes in addition to these. In one implementation, one or more of the techniques described herein can be implemented as features within an operating system or other program that provides context information to multiple applications, or from any other type of program or service that determines a device's context and/or uses the context to modify a device's behavior.

As one non-limiting example, a “property bag” can be used to hold a collection of context attributes. Any application or service that has interesting context information can be a “provider” and place values into the property bag. A non-limiting example of this would be a GPS service that calculates and publishes the current “location”. Alternatively or additionally, the application serving as the property bag can itself determine context information. In such scenarios using the property bag, one or more applications check the property bag for attributes of interest and decide how to react according to their values. Alternatively or additionally, applications can “listen” and be dynamically updated when a property changes. As another non-limiting example, one or more applications can determine context using their own logic and react appropriately to adjust the operation of the device accordingly based on the context.

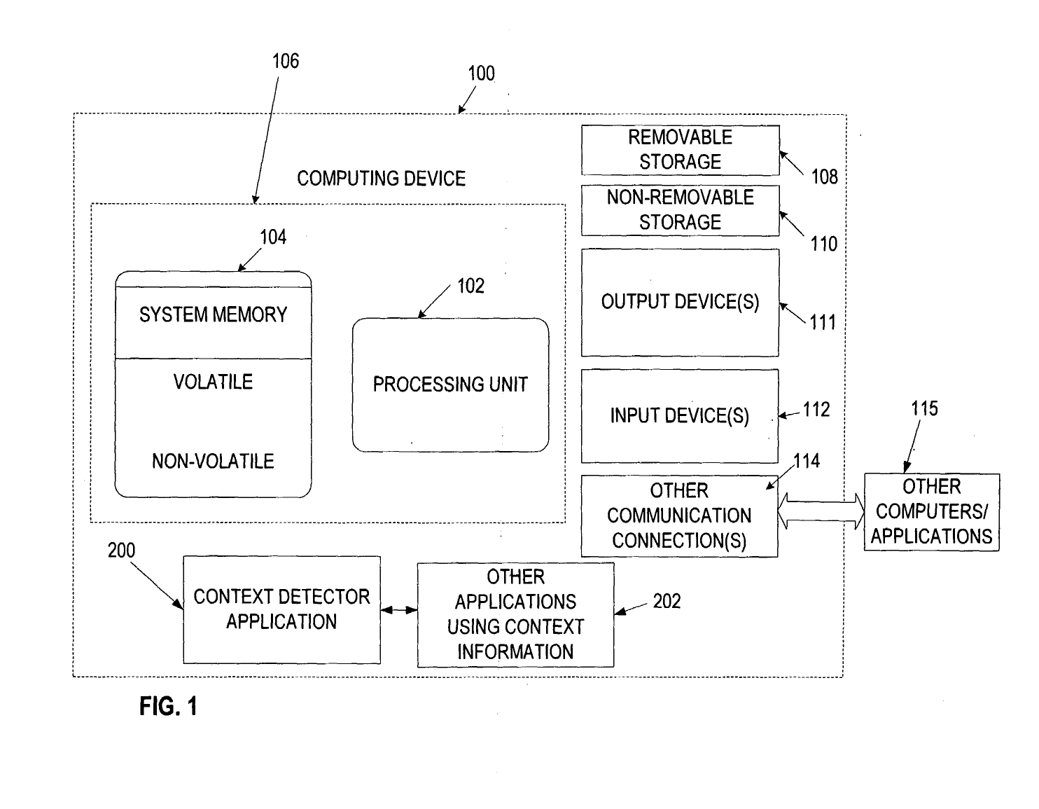

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

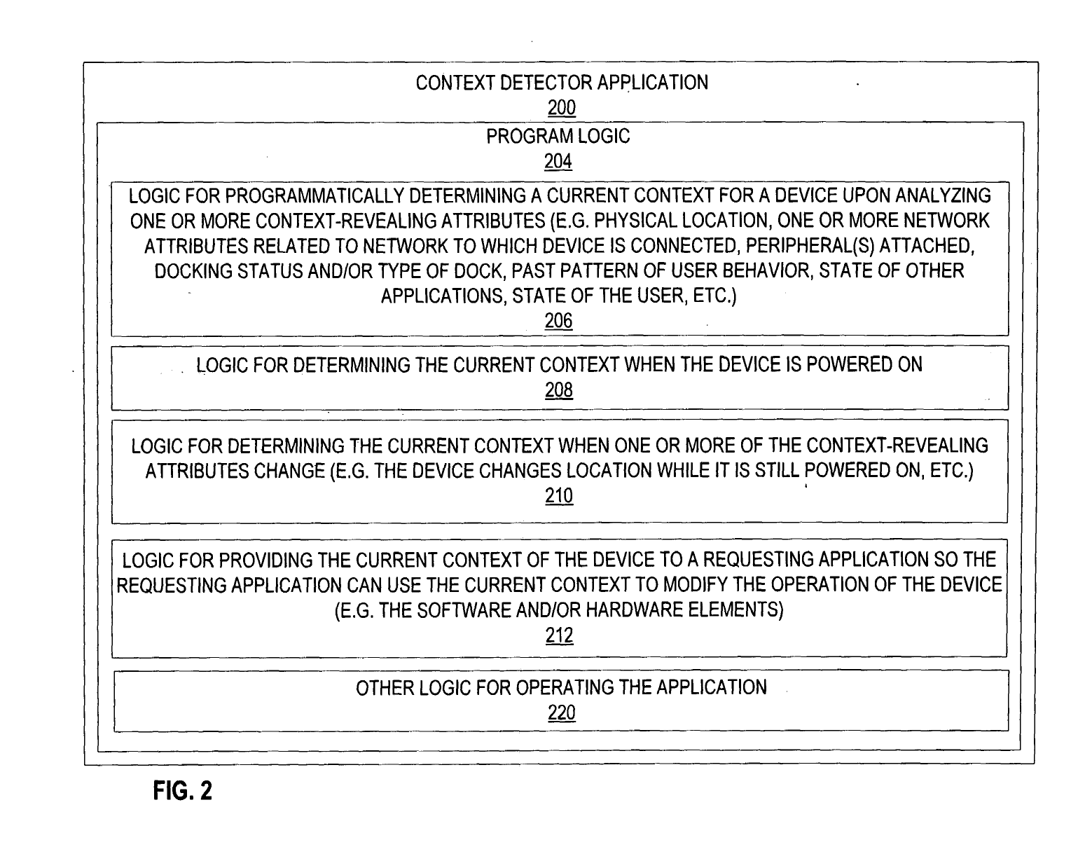

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes context detector application 200 and/or other applications 202 using the context information from context detector application 200. Context detector application 200 will be described in further detail in FIG. 2.

Turning now to FIG. 2 with continued reference to FIG. 1, a context detector application 200 operating on computing device 100 is illustrated. Context detector application 200 is one of the application programs that reside on computing device 100. However, it will be understood that context detector application 200 can alternatively or additionally be embodied as computer-executable instructions on one or more computers and/or in different variations than shown on FIG. 1. Although context detector application 200 is shown separately from other applications 202 that use context information, it will be appreciated that these two applications could be combined into the same application in alternate implementations. Alternatively or additionally, one or more parts of context detector application 200 can be part of system memory 104, on other computers and/or applications 115, or other such variations as would occur to one in the computer software art.

As described previously, in one implementation, context detector application 200 serves as a “property bag” of context information that other applications can query for the context information to determine how to alter the operation of the system. In one implementation, context detector application 200 determines the various context-revealing attributes and makes them available to other applications. In another implementation, other applications supply the context-revealing attributes to the context detector application 200, which then makes those context-revealing attributes available to any other applications desiring the information. Yet other variations are also possible.

Context detector application 200 includes program logic 204, which is responsible for carrying out some or all of the techniques described herein. Program logic 204 includes logic for programmatically determining a current context for a device upon analyzing one or more context-revealing attributes (e.g. physical location, peripheral(s) attached, one or more network attributes related to the network to which the device is attached, docking status and/or type of dock, past pattern of user behavior, the state of other applications, and/or the state of the user, etc.) 206; logic for determining the current context when the device is powered on 208; logic for determining the current context when one or more of the context-revealing attributes change (e.g. the device changes location while it is still powered on, etc.) 210; logic for providing the current context of the device to a requesting application so the requesting application can use the current context to modify the operation of the device (e.g. the software and/or hardware elements) 212; and other logic for operating application 220. In one implementation, program logic 204 is operable to be called programmatically from another program, such as using a single call to a procedure in program logic 204.

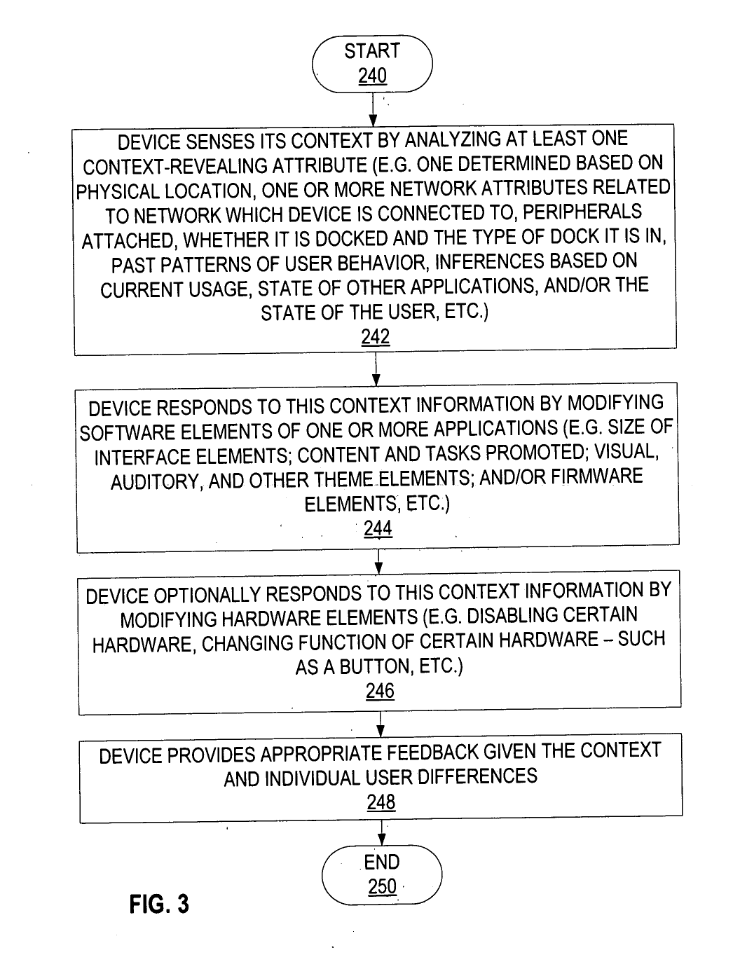

Turning now to FIGS. 3-10 with continued reference to FIGS. 1-2, the stages for implementing one or more implementations of context detector application 200 are described in further detail. FIG. 3 is a high level process flow diagram for one implementation of context detector application 200. In one form, the process of FIG. 3 is at least partially implemented in the operating logic of computing device 100. The procedure begins at start point 240 with a device determining/sensing its context by analyzing at least one context-revealing attribute (e.g. one determined based on physical location, peripherals attached, one or more network attributes related to the network to which the device is attached, whether it is docked and the type of dock it is in, past patterns of the user's behavior and inferences based on current usage, the state of other applications, and/or the state of the user, etc.) (stage 242). The device responds to this context information by modifying the software elements of one or more applications (e.g. size of the interface elements; content and tasks promoted; visual, auditory, and other theme elements; and/or firmware elements; etc.) (stage 244). The device optionally responds to this context information by modifying hardware elements (e.g. disabling certain hardware, changing function of certain hardware—such as a button, etc.) (stage 246). The device provides appropriate feedback given the context and individual user differences (stage 248). The process ends at end point 250.

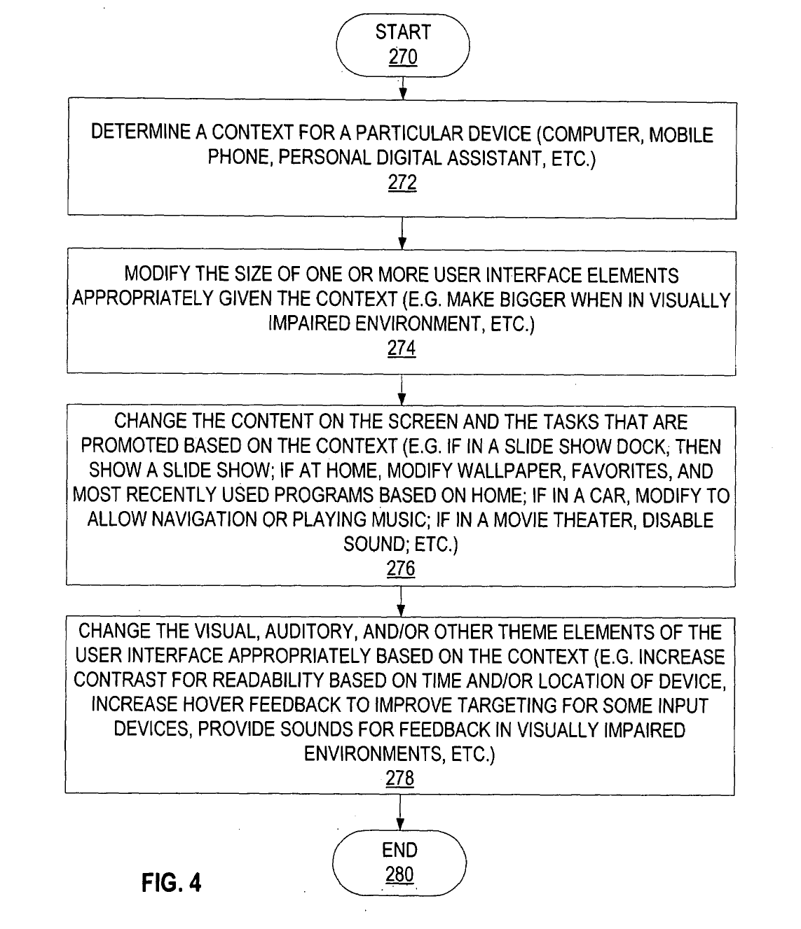

FIG. 4 illustrates one implementation of the stages involved in modifying various user interface elements based on device context. In one form, the process of FIG. 4 is at least partially implemented in the operating logic of computing device 100. The procedure begins at start point 270 with determining a context for a particular device (computer, mobile phone, personal digital assistant, etc.) (stage 272). The system modifies the size of one or more user interface elements appropriately given the context (e.g. makes some user interface elements bigger when in visually impaired environment, etc.) (stage 274).

The content on the screen and the tasks that are promoted based on the context are also changed as appropriate (stage 276). As a non-limiting example, if the device is docked in a picture frame dock, then the device may transform into a slideshow that shows the pictures. If the context of the user is determined to be at home, then the wallpaper, favorites list, most recently used programs based on home, and/or other user interface elements are modified based on home usage. If the context is a car, then the user interface can transform to serve as a music player and/or a navigation system. If the context is a movie theater, then sound can be disabled so as not to disturb others. Numerous other variations for modifying user interface content and the tasks that are promoted based on the context could be used instead of or in addition to these examples. Alternatively or additionally, the visual, auditory, and/or other theme elements of the user interface are modified appropriately based on the context (stage 278). As a few non-limiting examples, the contrast for readability can be increased or decreased based on time and/or location of the device, the hover feedback can be increased to improve targeting for some input devices, and/or sounds can be provided for feedback in visually impaired environments (stage 278). The process ends at end point 280.

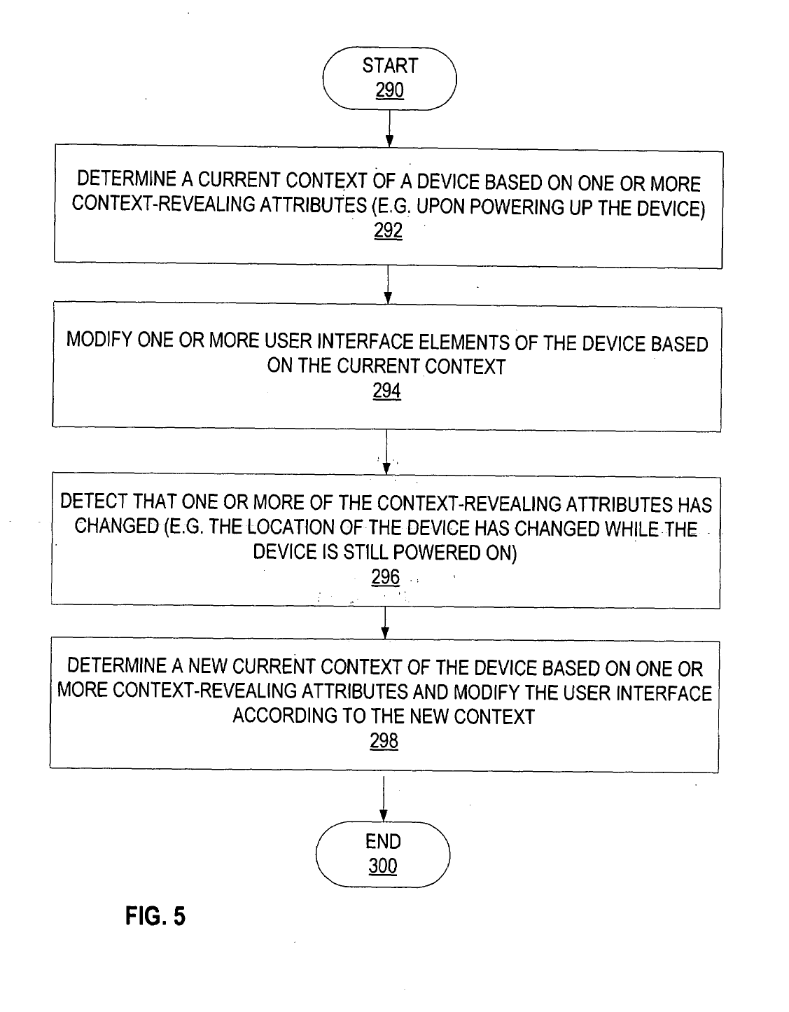

FIG. 5 illustrates one implementation of the stages involved in determining a current context of a device. In one form, the process of FIG. 5 is at least partially implemented in the operating logic of computing device 100. The procedure begins at start point 290 with determining a current context of a device based on one or more context-revealing attributes (e.g. upon powering up the device, etc.) (stage 292). One or more user interface elements of the device are modified appropriately based on the current context (stage 294). The system detects that one or more of the context-revealing attributes have changed (e.g. the location of the device has changed while the device is still powered on) (stage 296). A new current context of the device is determined/sensed based on one or more context-revealing attributes (stage 298). The system then modifies the user interface(s) according to the new context (stage 298). The process ends at end point 300.

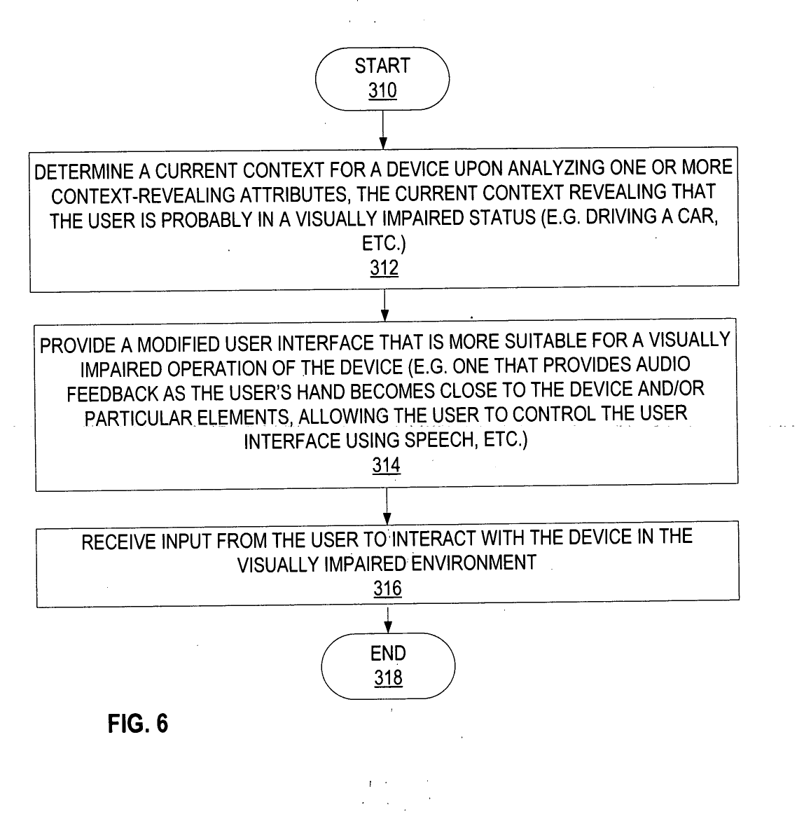

FIG. 6 illustrates one implementation of the stages involved in determining a visually impaired current context of a device. In one form, the process of FIG. 6 is at least partially implemented in the operating logic of computing device 100. The procedure begins at start point 310 with determining a current context for a device upon analyzing one or more context-revealing attributes, the current context revealing that the user is probably in a visually impaired status (e.g. driving a car, etc.) (stage 312). A modified user interface is provided that is more suitable for a visually impaired operation of the device (e.g. one that provides audio feedback as the user's hand becomes close to the device and/or particular elements, allowing the user to control the user interface using speech, etc.) (stage 314). The system receives input from the user to interact with the device in the visually impaired environment (stage 316). The process ends at end point 318.

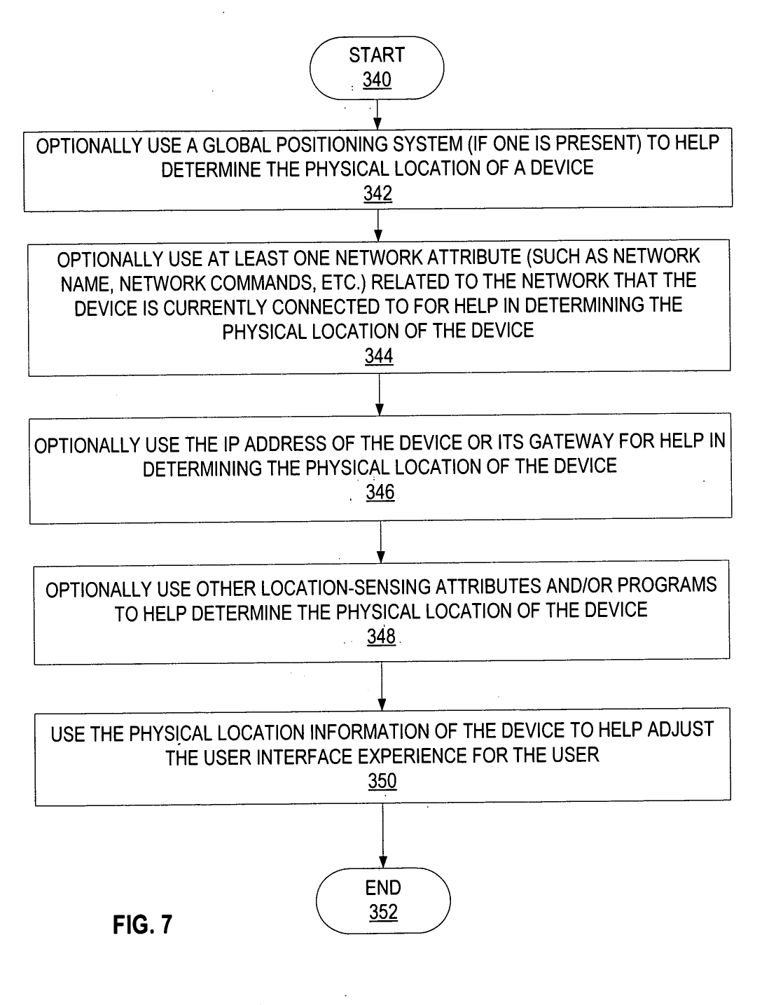

FIG. 7 illustrates one implementation of the stages involved in determining a physical location of a device to help determine context. In one form, the process of FIG. 7 is at least partially implemented in the operating logic of computing device 100. The procedure begins at start point 340 with optionally using a global positioning system (if one is present) to help determine the physical location of a device (stage 342). At least one network attribute (such as network name, network commands, etc.) related to the network that the device is currently connected to is optionally used for help in determining the physical location of the device (stage 344). Alternatively or additionally, the IP address of the device or its gateway is optionally used for help in determining the physical location of the device (stage 346). Other location-sensing attributes and/or programs to help determine the physical location of the device can also be used (stage 348). The physical location information of the device is then used to help adjust the user interface experience for the user (stage 350). The process ends at end point 352.

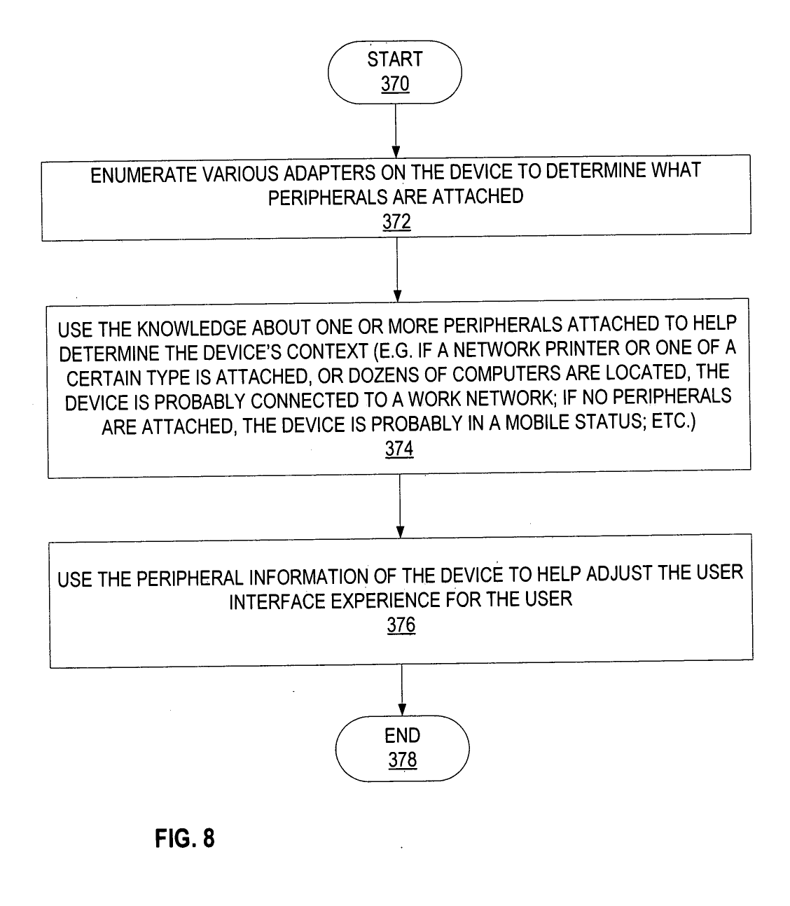

FIG. 8 illustrates one implementation of the stages involved in determining one or more peripherals attached to the device to help determine the device's context. In one form, the process of FIG. 8 is at least partially implemented in the operating logic of computing device 100. The procedure begins at start point 370 with enumerating various adapters on the device to determine what peripherals are attached (stage 372). The system uses the knowledge about one or more peripherals attached to help determine the device's context (e.g. if a network printer or one of a certain type is attached, or dozens of computers are located, the device is probably connected to a work network; if no peripherals are attached, the device is probably in a mobile status; etc.) (stage 374). The peripheral information of the device is then used to help adjust the user interface experience for the user (stage 376). The process ends at end point 378.

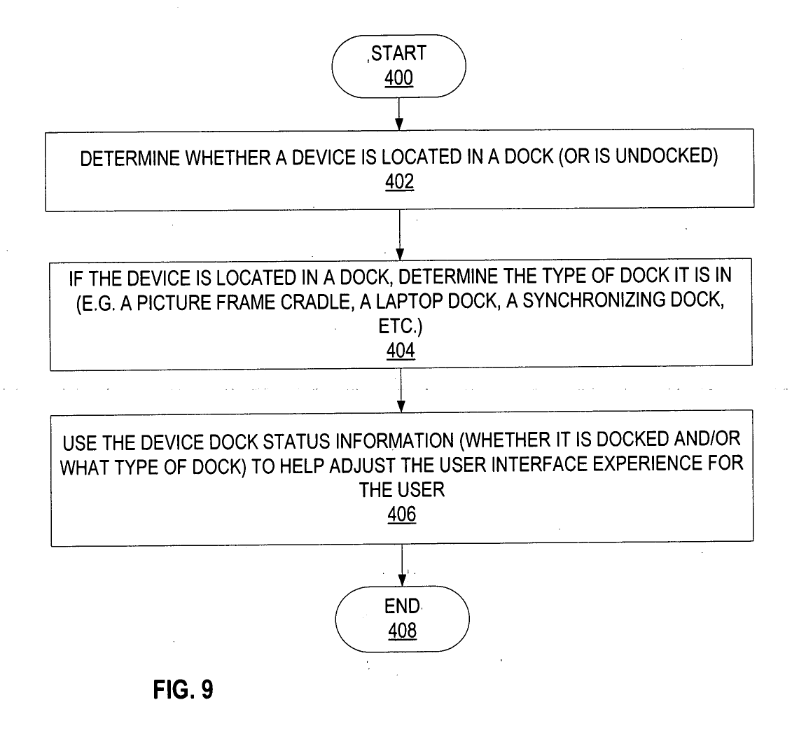

FIG. 9 illustrates one implementation of the stages involved in determining a docking status to help determine context. In one form, the process of FIG. 9 is at least partially implemented in the operating logic of computing device 100. The procedure begins at start point 400 with determining whether a device is located in a dock (or is undocked) (stage 402). If the device is located in a dock, the system determines the type of dock it is in (e.g. a picture frame cradle, a laptop dock, a synchronizing dock, etc.) (stage 404). The device dock status information (whether it is docked and/or what type of dock) is then used to help adjust the user interface experience for the user (stage 406). The process ends at end point 408.

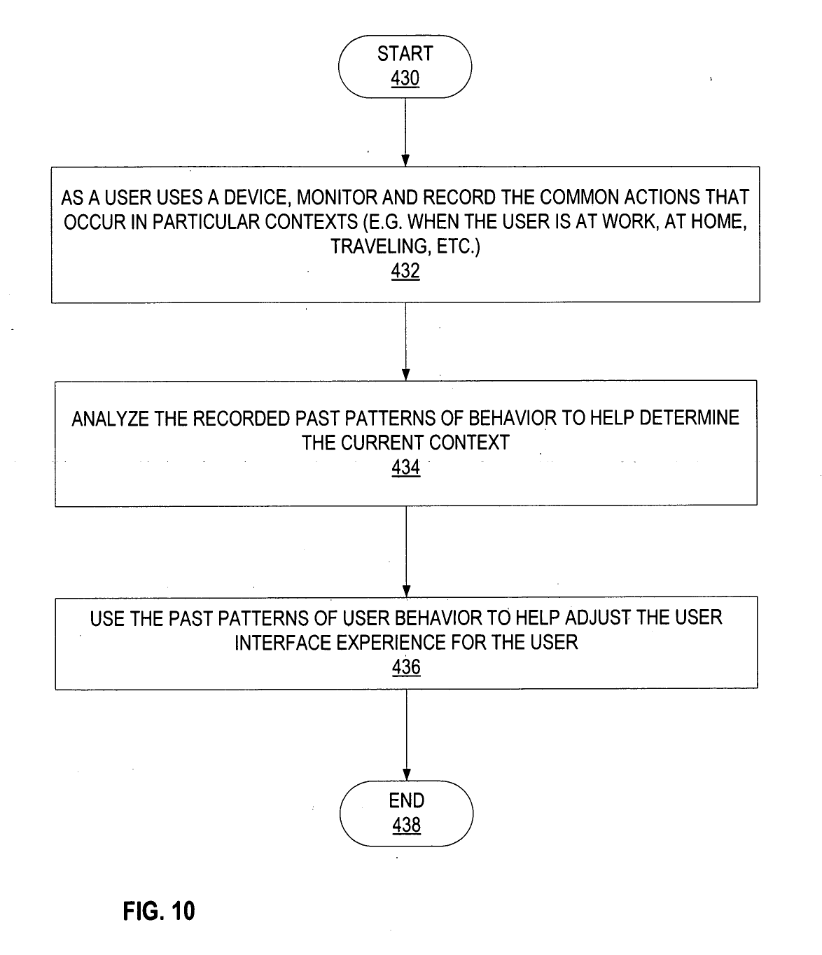

FIG. 10 illustrates one implementation of the stages involved in analyzing past patterns of user behavior to help determine context. In one form, the process of FIG. 10 is at least partially implemented in the operating logic of computing device 100. The procedure begins at start point 430 with monitoring and recording the common actions that occur in particular contexts as a user uses the device (e.g. when the user is at work, at home, traveling, etc.) (stage 432). The system analyzes the recorded past patterns of behavior to help determine the current context (stage 434). The past patterns of the user's behavior are used to help adjust the user interface experience for the user (stage 436). As one non-limiting example, if the user always loads a music player program when the device is docked in a car dock, then the system can automatically adjust future experiences in the car to automatically load the music player upon insertion into the car dock, or allow the user to load the music player program with a single command. The process ends at end point 438.

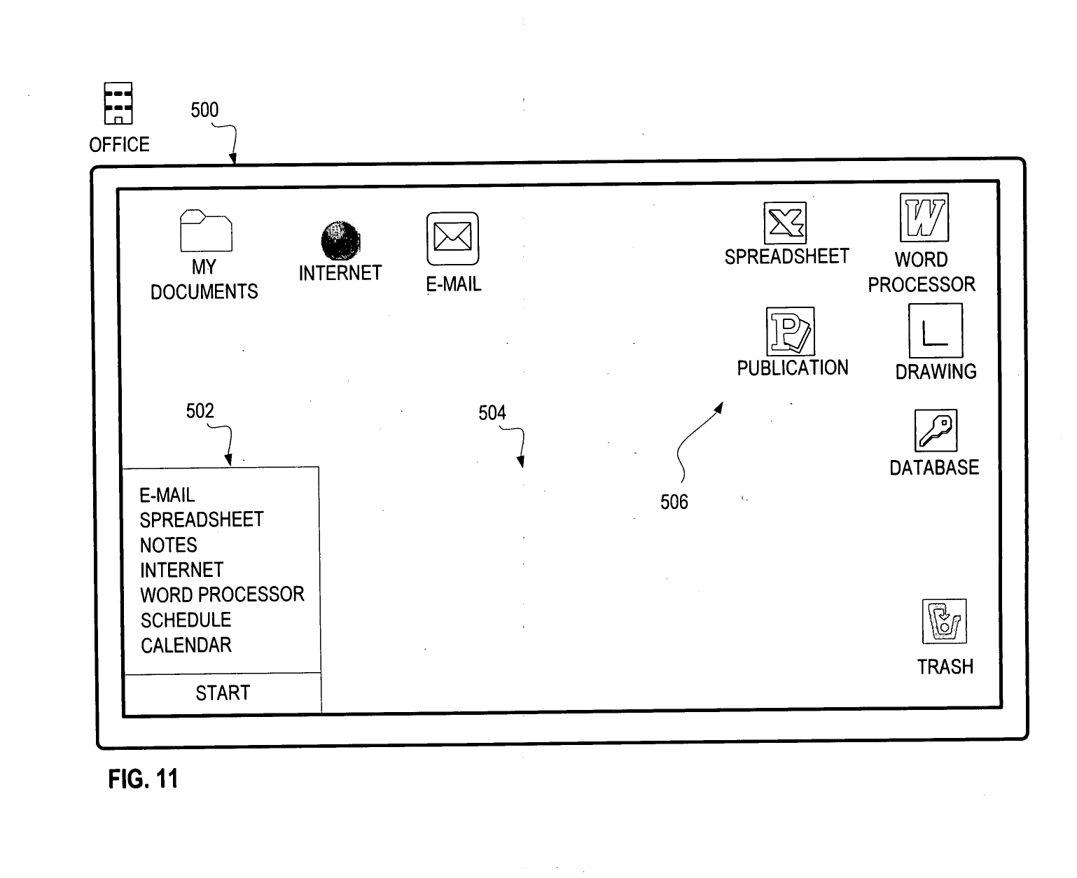

Turning now to FIGS. 11-15, simulated screens are shown to further illustrate the stages of FIGS. 3-10 to show how the same device transforms based on the particular context that it is operating in. These screens can be displayed to users on output device(s) 111. Furthermore, these screens can receive input from users from input device(s) 112.

FIG. 11 is a simulated screen 500 for one implementation of the system of FIG. 1 that illustrates adjusting user interface elements of a device based on a work context. Since context detector application 200 has determined that the user's context is “at work”, various user interface elements have been adjusted that are suitable for the user's work. For example, the start menu 502, icons 504, and wallpaper (plain/solid background) 506 are set based on the work context.

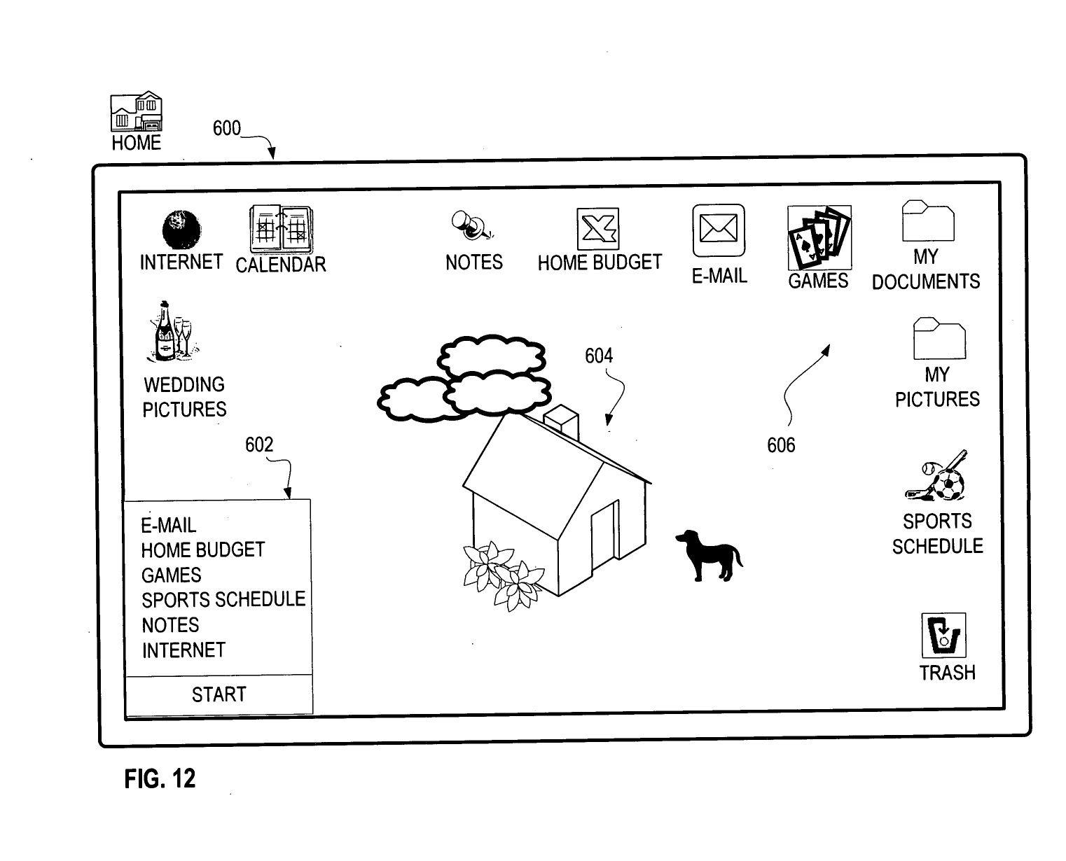

FIG. 12 is a simulated screen 600 for one implementation of the system of FIG. 1 that illustrates adjusting user interface elements of a device based on a home context. Since context detector application 200 has determined that the user's context is now “at home”, various user interface elements have been adjusted that are suitable for the user's home. For example, the start menu 602, icons 604, and wallpaper (now with the family home picture) 606 are set based on the home context.

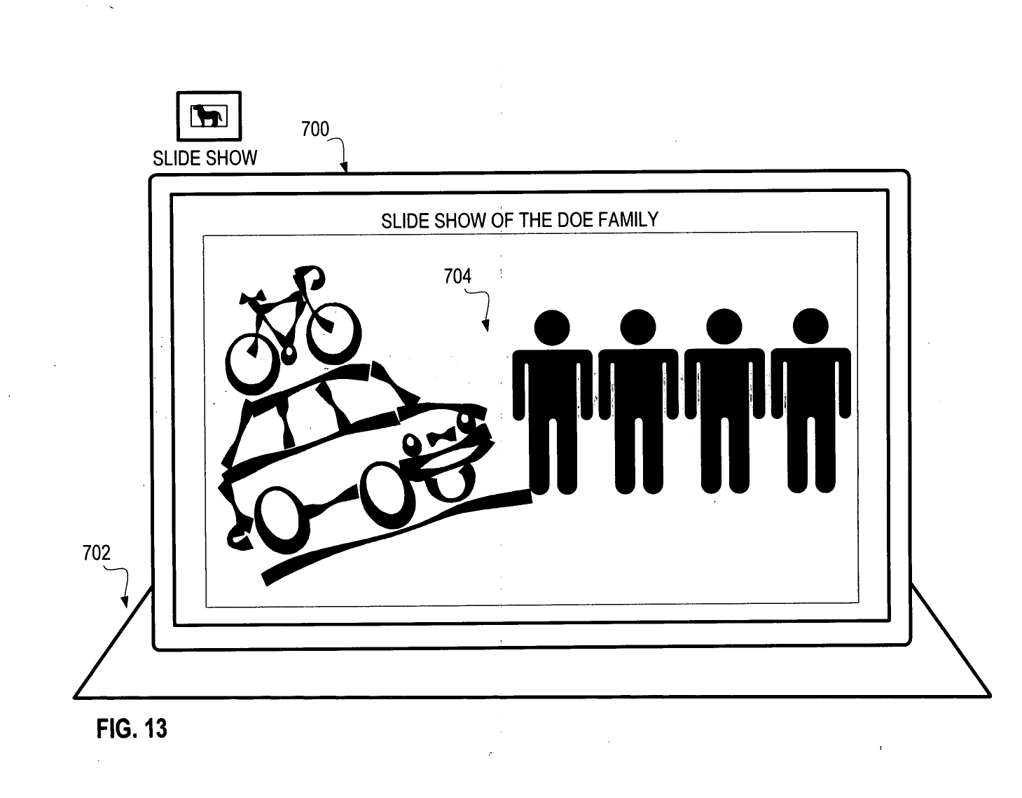

FIG. 13 is a simulated screen 700 for one implementation of the system of FIG. 1 that illustrates transforming the device into a photo slideshow player based on a picture frame cradle the device is docked in. Upon docking the device into the picture frame cradle 702, the photo slideshow 704 of the John Doe family automatically starts playing. In one implementation, the other applications are disabled so the device only operates as a slide show player while docked in the picture frame cradle 702. In another implementation, the other applications are hidden from the user until a certain action (e.g. closing the slide show) is taken to alter the slide show player mode.

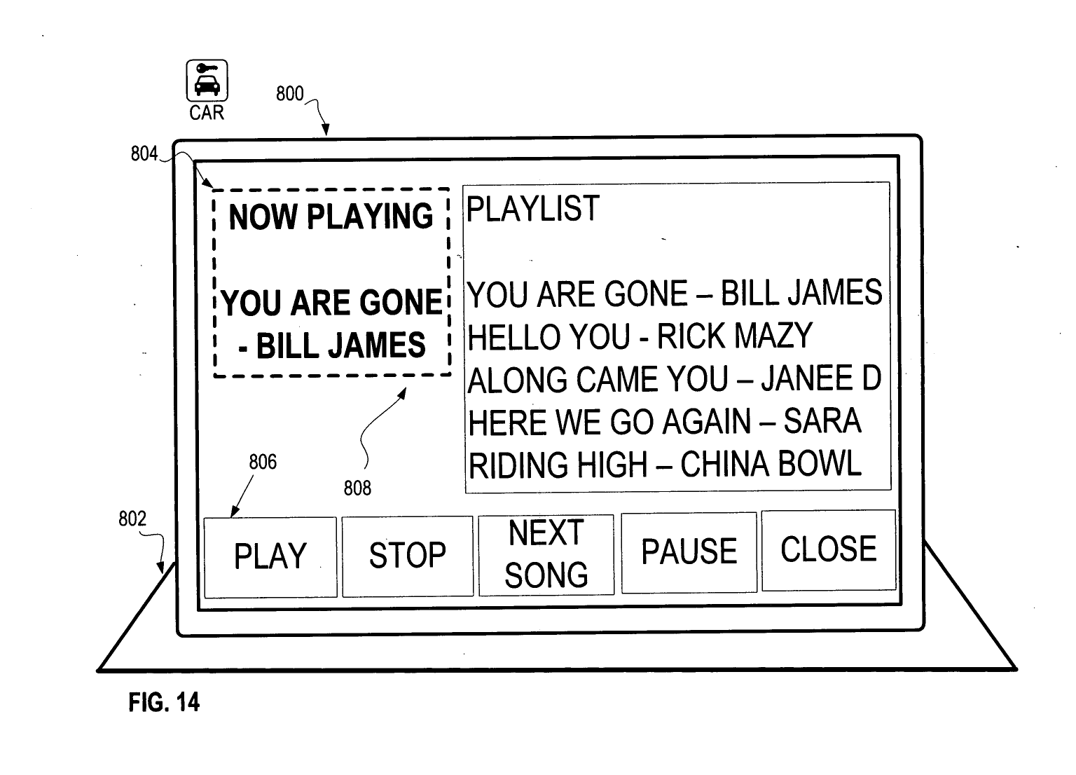

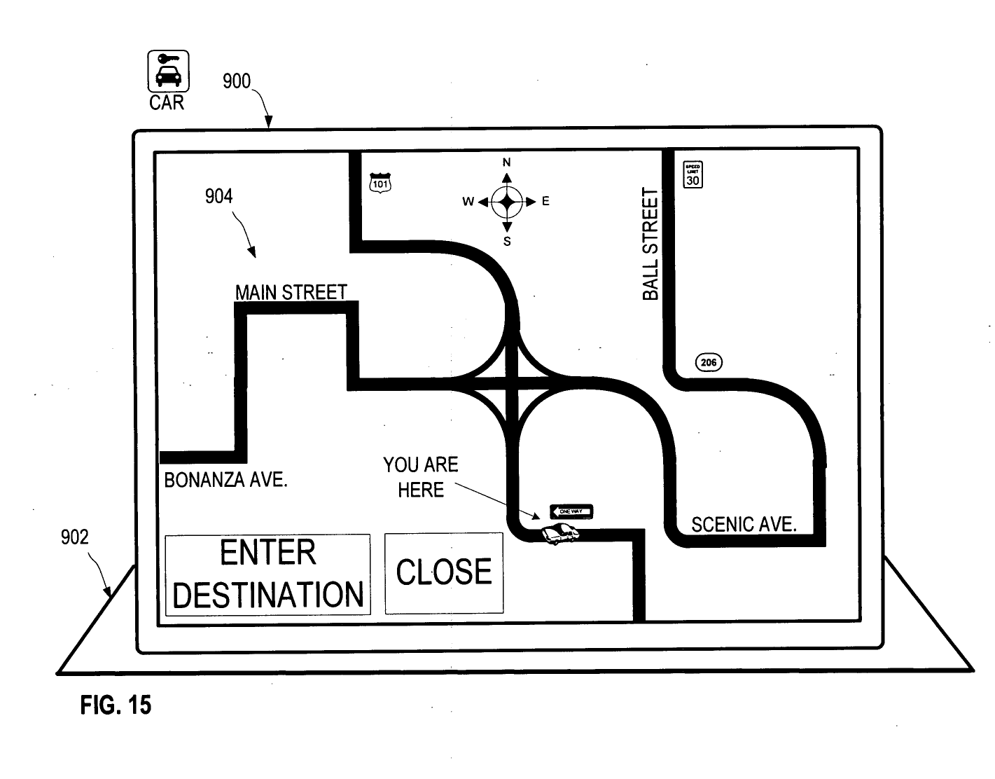

FIG. 14 is a simulated screen 800 for one implementation of the system of FIG. 1 that illustrates transforming the device into a music player based on a car context. The device is docked into a car dock 802. The device is currently operating as a music player 804, and various user interface elements, such as the buttons 806 and the font size of the songs 808 have been adjusted to account for this visually impaired environment (e.g. driving a car). In one implementation, as the user's finger draws closer to the buttons, audible feedback is given to the user so they can interact with the user interface more easily in the reduced visibility environment. Similarly, FIG. 15 is a simulated screen 900 for one implementation of the system of FIG. 1 that illustrates transforming the device into a navigation system based on a car context. As with FIG. 14, the device is docked into a car dock 902. The device is currently operating as a navigation system 904, and the user interface elements have been adjusted for accordingly. In one implementation, a prior usage history of the user in the car is used to determine whether to display the music player or the navigation system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for transforming an operation of a device based on context comprising the steps of:
determining a current context for a device, the current context being determined upon analyzing at least one context-revealing attribute selected from the group consisting of a physical location of the device, at least one network attribute related to a network to which the device is connected, at least one peripheral attached to the device, a particular docking status, and a past pattern of user behavior with the device; and
modifying at least one software element of a user interface on the device based upon the current context.

2. The method of claim 1, further comprising:
modifying at least one hardware element of the device based upon the current context.

3. The method of claim 2, wherein the at least one hardware element is modified by changing an operation that occurs when a particular hardware element is accessed.

4. The method of claim 3, wherein the hardware element is a button.

5. The method of claim 2, wherein the at least one hardware element of the device is modified by disabling the at least one hardware element.

6. The method of claim 1, wherein the at least one software element is selected from the group consisting of a size of at least one element on the user interface, a particular content included on the user interface, a particular one or more tasks promoted by the user interface, a visual element of the user interface, an auditory element of the user interface, and a theme element of the user interface.

7. The method of claim 1, wherein the current context is determined when the device is initially powered on.

8. The method of claim 1, wherein the current context is determined when the at least one context-revealing attribute is determined to have changed from a prior status.

9. The method of claim 1, wherein the context-revealing attribute for the physical location of the device is determined at least in part using a global positioning system.

10. The method of claim 1, wherein the context-revealing attribute for the physical location of the device is determined at least in part by analyzing the at least one network attribute.

11. The method of claim 1, wherein the context-revealing attribute for the physical location of the device is determined at least in part by analyzing an IP address currently assigned to the device.

12. The method of claim 1, wherein the context-revealing attribute for the particular docking status is determined at least in part by analyzing a type of dock the device is docked in.

13. A computer-readable medium having computer-executable instructions for causing a computer to perform the steps recited in claim 1.

14. A computer-readable medium having computer-executable instructions for causing a computer to perform steps comprising:
determine a current context for a device, the current context being determined upon analyzing at least one context-revealing attribute selected from the group consisting of a physical location of the device, at least one peripheral attached to the device, at least one network attribute related to a network to which the device is connected, a particular docking status, and a past pattern of user behavior with the device; and
provide the current context of the device to a requesting application, whereby the requesting application uses the current context information to modify the operation of the device.

15. The computer-readable medium of claim 14, further having computer-executable instructions for causing a computer to perform steps comprising:
determine the current context for the device when the device is powered on.

16. The computer-readable medium of claim 14, further having computer-executable instructions for causing a computer to perform steps comprising:
determine the current context for the device when the at least one context-revealing attribute changes.

17. A method for transforming an operation of a device based on a detected visually impaired context comprising the steps of:
determining a current context for a device, the current context indicating a probable visually impaired status of a user; and
providing a modified user interface that is more suitable for a visually impaired operation of the device, the modified user interface being operable to provide audio feedback when a hand of the user is close to a particular element on the modified user interface.

18. The method of claim 17, wherein the current context is determined upon analyzing at least one context-revealing attribute selected from the group consisting of a physical location of the device, at least one peripheral attached to the device, at least one network attribute related to a network to which the device is connected, a particular docking status, and a past pattern of user behavior with the device.

19. The method of claim 17, wherein the modified user interface is further operable to be controlled by the user at least in part using one or more speech commands.

20. A computer-readable medium having computer-executable instructions for causing a computer to perform the steps recited in claim 17.
